(19) United States
(12) Patent Application Publication
(10) Pub. No.: US 2026/0187999 A1
(43) Pub. Date: Jul. 2, 2026

(54) IMAGE PROCESSING METHOD, INFORMATION PROVISION DEVICE, AND INFORMATION PROCESSING PROGRAM

(71) Applicant: SONY GROUP CORPORATION, TOKYO (JP)

(72) Inventors: SHLOK MOHTA, TOKYO (JP); HISAHIRO SUGANUMA, TOKYO (JP)

(21) Appl. No.: 18/862,724

(22) PCT Filed: Apr. 12, 2023
(86) PCT No.: PCT/JP2023/014808

§ 371 Date: Nov. 4, 2024

(30) Foreign Application Priority Data
May 9, 2022 (JP) 2022-076940

(51) Int. Cl. G06V 10/96; G06V 10/26; G06V 10/42; G06V 10/44; G06V 10/70; G06V 10/82; G06V 10/94

(52) U.S. Cl. CPC G06V 10/96; G06V 10/26; G06V 10/42; G06V 10/44; G06V 10/82; G06V 10/87; G06V 10/945

(57) ABSTRACT

To enable a user to easily recognize how the accuracy of a ViT and the amount of resources required for processing change when a setting of various hyperparameters is changed. An image processing method according to an embodiment executes processing of: accepting, from a user, an input regarding execution of image processing using a learning model; setting, according to the accepted input, a control parameter of processing regarding image recognition; generating, according to the control parameter, attribute data of image data to be processed; generating, according to the control parameter, close observation information from the attribute data; and performing image recognition on the basis of the close observation information.

### FIELD

The present invention relates to an image processing method, an information provision device, and an information processing program.

### BACKGROUND

Thus far, a service in which image recognition is performed on the basis of features included in an image and information according to the recognition result is provided has been known. For example, there is known a technology in which a vision transformer (ViT), which is inspired by transformer architecture spread by use in natural language processing, is used to acquire a result of recognition of an image according to an object to be imaged and information according to the acquired recognition result is provided.

### CITATION LIST

### Non Patent Literature

Non Patent Literature 1: Vaswani et al., “Attention is All You Need”. NIPS 2017

### SUMMARY

### Technical Problem

In such a ViT, there are a plurality of hyperparameters, and the accuracy of the ViT and the amount of resources required for processing using the ViT change according to the setting of hyperparameters. However, it is difficult for the user to recognize how the accuracy of the ViT and the amount of resources required for processing change when a setting of various hyperparameters is changed.

The present disclosure has been made in view of the above, and enables the user to easily recognize how the accuracy of the ViT and the amount of resources required for processing change when a setting of various hyperparameters is changed.

### Solution to Problem

According to the present disclosure, an image processing method includes execution of processing of: accepting, from a user, an input regarding execution of image processing using a learning model; setting, according to the accepted input, a control parameter of processing regarding image recognition; generating, according to the control parameter, attribute data of image data to be processed; generating, according to the control parameter, close observation information from the attribute data; and performing image recognition on the basis of the close observation information.

### BRIEF DESCRIPTION OF DRAWINGS

FIG. 1 is an explanatory diagram for describing an information provision system according to an embodiment.

FIG. 2 is an explanatory diagram for describing an outline of a ViT architecture.

FIG. 3 is an explanatory diagram for describing the inside of a block.

FIG. 4 is an explanatory diagram for describing the inside of multi-head self-attention.

FIG. 5 is an explanatory diagram for describing resources for calculating QKV.

FIG. 6 is an explanatory diagram for describing information processing (processing regarding QKV) according to a first embodiment.

FIG. 7 is an explanatory diagram for describing information processing (processing regarding MRL) according to the first embodiment.

FIG. 8 is a diagram illustrating a configuration example of an information provision device according to the first embodiment.

FIG. 9 is a diagram illustrating an example of a model database according to the first embodiment.

FIG. 10 is a diagram illustrating an example of an image data database according to the first embodiment.

FIG. 11 is an explanatory diagram for describing processing of a recognition processing execution unit according to the first embodiment.

FIG. 12 is an explanatory diagram for describing a user interface according to a second embodiment.

FIG. 13 is an explanatory diagram for describing processing of a setting unit according to the second embodiment.

FIG. 14 is a hardware configuration diagram illustrating an example of a computer that implements functions of an information provision device.

### DESCRIPTION OF EMBODIMENTS

Hereinbelow, preferred embodiments of the present disclosure are described in detail with reference to the appended drawings. In the present specification and the drawings, components having substantially the same functional configurations are denoted by the same reference numerals, and a repeated description is omitted.

The description will be given in the following order.
1. Configuration of an information processing system
2. Processing according to a first embodiment
3. Configuration of an information provision device
4. Processing according to a second embodiment
5. Hardware configuration example
6. Conclusions

### 1. Configuration of an Information Provision System

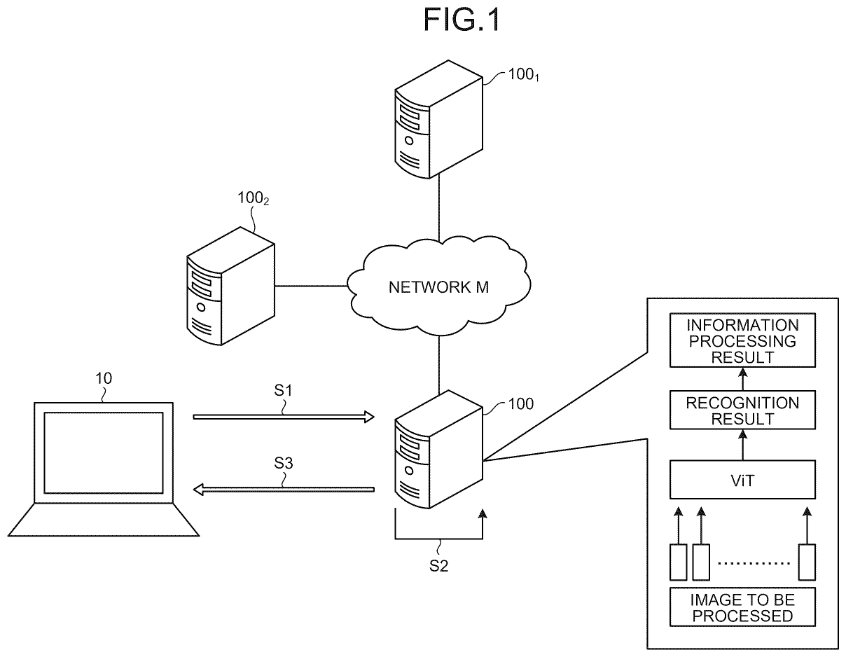

An example of an information provision system according to an embodiment will now be described using FIG. 1. FIG. 1 is an explanatory diagram for describing an information provision system according to an embodiment.

A user terminal 10 is a terminal device used by a user. The user terminal 10 may be any device as long as it can implement processing in the embodiment, such as a smartphone, a tablet terminal, a notebook PC, a desktop PC, a mobile phone, or a PDA.

An information provision device 100 is an information processing device that provides a result of performing image processing by an image processing method of the present disclosure. As a specific example, the information provision device 100 executes processing of recognizing a designated image, and executes information processing according to the result of recognition processing. Then, the information provision device 100 provides the result of information processing.

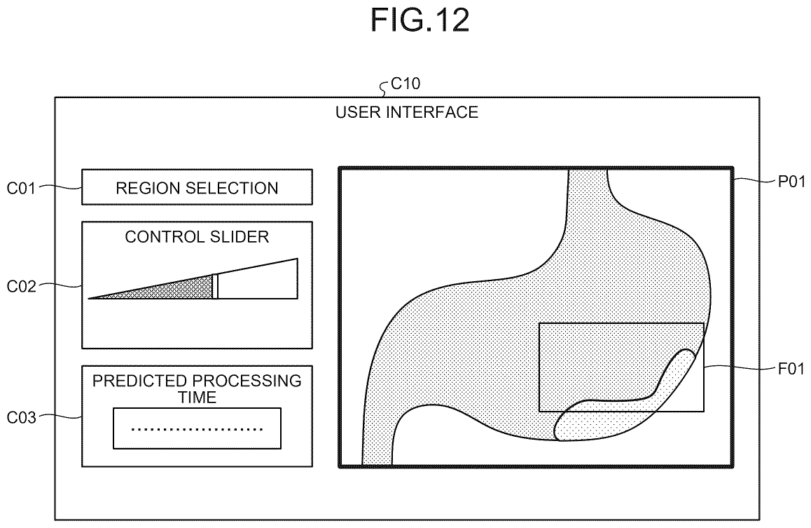

For example, when the information provision device 100 accepts, as an image to be processed, designation of a captured pathological image or data of a pathological image (hereinafter, referred to as image data), the information provision device 100 performs processing of recognizing the pathological image. More specifically, when the information provision device 100 accepts a CT image of a stomach or the like (see FIG. 12), the information provision device 100 recognizes whether a lesion such as a tumor has occurred or not, and executes information processing according to the recognition result. Then, the information provision device 100 provides the result of execution of information processing. In FIG. 1, when the information provision device 100 acquires information regarding designation of an image or image data transmitted from the user terminal 10 (Step S1), the information provision device 100 executes recognition processing and information processing according to the recognition result (Step S2), and transmits the execution result to the user terminal 10 (Step S3). There may be a plurality of information provision devices 100, and the information provision devices can be connected to be able to communicate with each other by wire or wirelessly via a predetermined communication network (a network M). The network M may be some kind of wired or wireless network, such as a local network, a wide area network, or a cloud. When there are a plurality of information provision devices 100, the user terminal 10 may be connected to the network M by wire or wirelessly, and may perform transmission and reception of information with an arbitrary information provision device 100 via the network M to perform processing of the information provision device 100 by distributed processing.

Here, the information provision device 100 executes image recognition processing by using a ViT, which is inspired by a transformer. The ViT is inspired by transformer architecture spread by use in natural language processing, and is a deep neural network architecture designed to process an input from the “vision” domain (hereinafter, occasionally referred to as a “visual domain”), such as an image or a moving image.

For example, the information provision device 100 divides image data into a plurality of regions, and inputs the image data to the ViT. The ViT calculates the strength of relevance (what is called attention) of a feature belonging to each region, and on the basis of the calculated values of attention, outputs a recognition result according to the object imaged in the image data or the state of the object. Then, the information provision device 100 generates an information processing result from the recognition result, and provides the generated information processing result.

### 2. Processing According to a First Embodiment

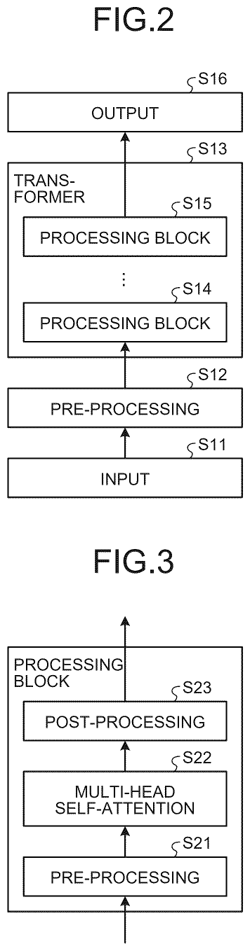

Next, an outline of an architecture included in a ViT is described prior to the description of an image processing method executed by the information provision device 100. FIG. 2 is an explanatory diagram for describing an outline of a ViT architecture. The ViT architecture is composed of various components described as follows. The ViT architecture receives an input (S11). In the present disclosure, for example, various images belonging to the visual domain are handled as inputs, including not only images and moving images captured by various cameras (that is, images acquired by measurement in the visible light region) but also images captured in the X-ray region, such as CT images and X-ray images, and an image in which a result of magnetic force measurement such as MRI (magnetic resonance imaging) is imaged. Subsequently, the input (S11) is provided as an input to pre-processing (S12). The pre-processing (S12) is processing of modifying inputted information, or processing of, using various neural network layers, generating an appropriate output to be provided to a layer subsequent to the ViT architecture. Processing similar to various conventional technologies employing various ViT architectures can be employed as the pre-processing (S12), and examples include processing of dividing an inputted image into a plurality of regions, extraction of a feature value for each divided region, etc.

The output from the pre-processing (S12) is further processed by a transformer block (S13) composed of a plurality of processing blocks (S14 and S15) sequentially stacked. An arbitrary number of processing blocks in the transformer can be set as network design parameters. Further, an arbitrary number of transformers (S13) in the ViT can be set as network design parameters.

The output from the transformer block is provided as an input to a post-processing/output (S16) portion of the architecture, and is transformed into an appropriate output according to the task. This output may be, for example, a score for each object category for an input image recognition task.

Next, details of the inside of the processing block are described. FIG. 3 is an explanatory diagram for describing the inside of the processing block. An output of the pre-processing (S12) or an output of a processing block placed in an earlier stage is inputted to the processing block. In the processing block, an input from an earlier stage is processed by pre-processing (S21) to be able to be inputted to multi-head self-attention (S22), and an output of the pre-processing is inputted to the multi-head self-attention (S22). Then, the output of the multi-head self-attention (S22) is inputted to post-processing (S23), is subjected to various feature corrections and feature extractions, and is transformed into data for subsequent processing.

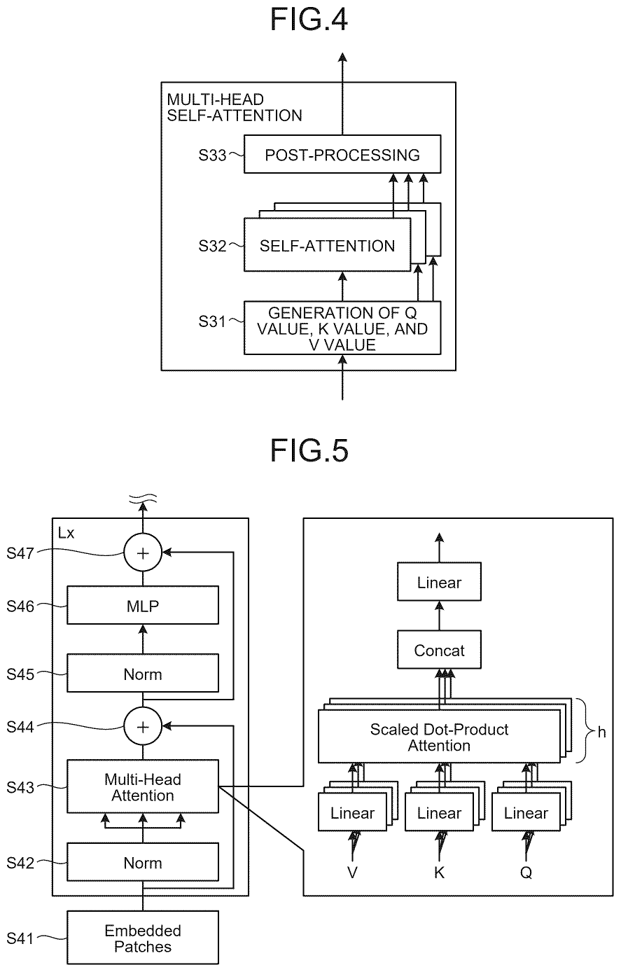

Next, processing in the multi-head self-attention (S22) is described. FIG. 4 is an explanatory diagram for describing processing of multi-head self-attention. In the multi-head self-attention, on the basis of an input, a set of QKV values (Q value (query value), K value (key value), V value (value value)) for calculating attention is generated by a neural network or the like for each region obtained by dividing the inputted image (S31). The generated set of QKV is split into h equal partitions along a specific dimension, and processing of obtaining an individual self-attention (S32) is performed for each partition. That is, in the multi-head self-attention, a plurality of self-attentions (S32) exist according to the number of sets of QKV generated. Next, the output of self-attention (S32) calculated for each of the h split partitions is provided as an input to post-processing (S33). In the post-processing (S33), the output of each self-attention (S32) is further processed to function as an input to the next layer.

In such a ViT architecture, a large amount of resources are required for learning and estimation of the self-attention (S32). For example, in the case where the resolution of an inputted image is large and the number of regions after division is increased or in the case where the number of types of feature values extracted from each region is large, although the accuracy of the processing result can be enhanced, the amount of memory required for calculation and the amount of calculation are increased, and the overall calculation efficiency of the neural network architecture may be reduced.

FIG. 5 is an explanatory diagram for describing resources for calculating QKV. FIG. 5 is a more detailed diagram of FIG. 4. In the example illustrated in FIG. 5, the processing of Steps S42 to S47 indicated by a processing block Lx corresponds to one processing block illustrated in FIG. 2. For example, the processing block Lx obtains, from a previous processing block, data in the visual domain as a processing result. Then, the data in the visual domain is divided into a plurality of regions by embedded patches (S41), and the resulting data is inputted to the processing block Lx.

Subsequently, in the processing block Lx, upon accepting the input of data (S41), normalization (S42) is performed, and QKV values are calculated. Then, in the processing block Lx, multi-head attention (S43) is calculated for each of the QKV values. Here, regarding the QKV values, a plurality of sets of QRV values are generated in parallel for one region, and multi-head attention (S43) is calculated for each set of QKV values generated in parallel.

After that, in the processing block Lx, an output result based on the multi-head attention, that is, the region-wise strength of relevance and the inputted data of the respective region are added (S44), and normalization (S45) is performed again. After that, in the processing block Lx, linear transformation (S46) is performed, an output result based on the linear transformation and the output of Step S44 are added (S47), and the result is outputted. A unit in which a plurality of processing blocks Lx are stacked corresponds to the transformer S13 illustrated in FIG. 2.

Here, as illustrated on the right side of FIG. 5, in the multi-head attention (S43), a plurality of sets of QKV values are calculated in parallel for each region, and accordingly pluralities of sets of QKV values calculated for all the regions are generated. Then, scaled dot-product attention processing is executed for each generated set. For example, in the case where h sets of QKV values are generated in parallel for each region, scaled dot-product attention processing is executed in parallel for the h sets of QKV values.

Here, in the conventional multi-head attention (S43), each of the Q value, the K value, and the V value is calculated by an individual transformation function. However, when the Q value, the K value, and the V value are calculated by individual linear transformations, the amount of resources at the time of learning or use is increased.

Further, the ViT architecture may use a large number of weight parameters in order to calculate QKV values, in addition to calculation requirements for the ViT architecture model. Further, the ViT architecture lacks a unique method to take into account an inductive bias included in a data set used for learning of the ViT. Although such a problem regarding inductive bias can be alleviated by increasing the number of parameters, the amount of processing resources is increased when the number of parameters is increased. Further, when the number of data sets is not sufficient, it is feared that the problem regarding inductive bias cannot be sufficiently alleviated.

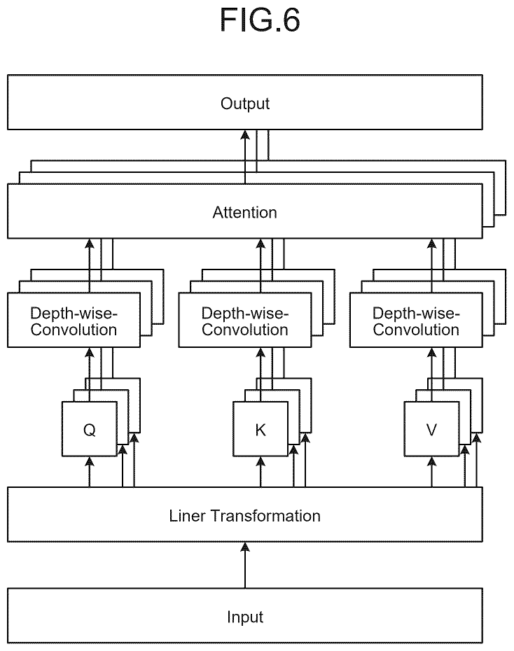

Thus, in the information processing in the first embodiment, the QKV values to be calculated in parallel are not calculated by individual linear transformations, but common QKV generated from a common basis function is employed. FIG. 6 is an explanatory diagram for describing information processing (processing regarding QKV) according to the first embodiment. In FIG. 6, the values of the Q value, the K value, and the V value are not generated from individual linear transformations, but are generated by a common basis transformation. Then, in the information processing in the first embodiment, depth-wise convolution is applied to each of the QKV values, calculation of attention based on the output result is performed, and thereby an output result is generated.

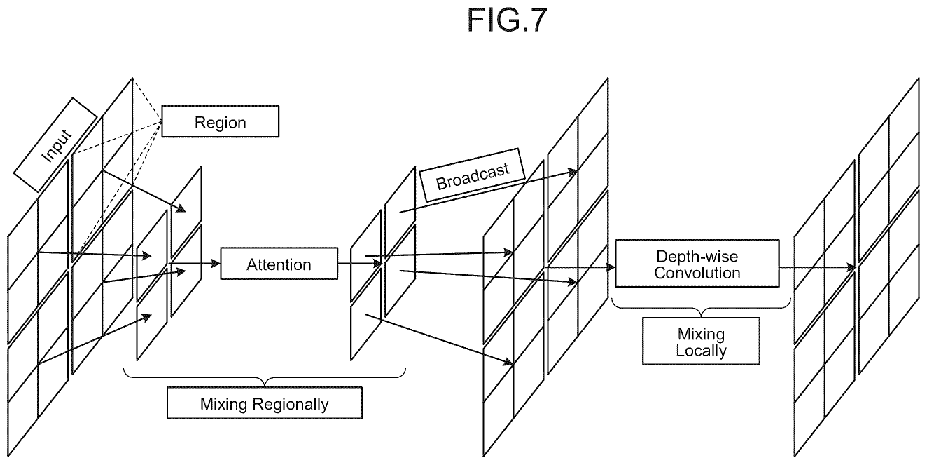

Further, in the information processing in the first embodiment, processing to which MRL (Mixing Regionally and Locally), in which global features and local features of an image to be processed are mixed, is applied is performed. FIG. 7 is an explanatory diagram for describing information processing (processing regarding MRL) according to the first embodiment. In the conventional ViT, the calculation of scaled dot-product attention is individually performed for each region of an image, and the amount of calculation of O (Formula (1) below) is needed for the calculation. Therefore, in image processing, an amount of resources proportional to the square of the image size is needed.

$$0 = channel * N \hat{} 2 \qquad ( 1 )$$

Thus, in the present disclosure, the amount of resources is reduced by applying MRL. In FIG. 7, it is assumed that there are 4×4 regions in an image to be processed. In processing employing MRL, first, the 4×4 regions are aggregated into 2×2 regions. Specifically, processing of aggregating the feature values of four adjacent cells into one cell is performed. For example, the feature value of one aggregated cell is the average value of the feature values of the four cells. Then, processing of calculating attention is executed for each of the feature values of the four cells after aggregation. The processing of calculating attention illustrated in FIG. 7 corresponds to the entire processing from the input to the output illustrated in FIG. 6. By the processing of calculating attention, information indicating relevance of the four cells (for example, information indicating the strengths of relevance) is outputted. By performing such processing, in the present disclosure, global features of the regions are mixed.

Subsequently, the value of attention calculated for each of the four cells is expanded to the original four cells before aggregation. For example, in the present disclosure, the value of attention calculated for one region among the 2×2 regions is applied to the regions of adjacent four cells among 4×4 regions. As a result, the 2×2 regions are expanded to 4×4 regions again.

Then, in the present disclosure, for features corresponding to each of the cells after expansion, depth-wise convolution is applied for each cell; thereby, a feature value in which a plurality of types of features included in each cell are convolved for each cell is generated. Thus, the information provision device 100 divides input data into a plurality of regions, aggregates feature values of the divided regions into feature values of a smaller number of regions, and executes processing of calculating attention based on the aggregated feature values, and thereby calculates attention based on global features. Then, the information provision device 100 expands the values of attention to the original regions before division and applies depth-wise convolution, and thereby calculates local features.

### 3. Configuration of an Information Provision Device

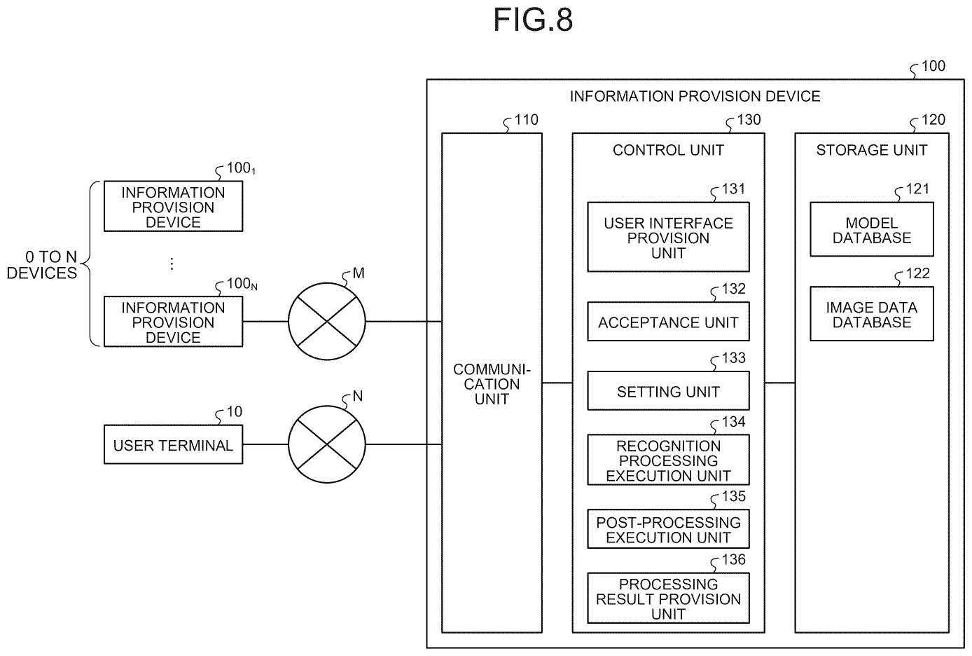

Next, a configuration of the information provision device 100 according to the first embodiment is described using FIG. 8. FIG. 8 is a diagram illustrating a configuration example of the information provision device 100 according to the first embodiment. As illustrated in FIG. 8, the user terminal 10 and the information provision device 100 are connected to be able to communicate with each other by wire or wirelessly via a predetermined communication network (a network N). As illustrated in FIG. 8, the information provision device 100 includes a communication unit 110, a storage unit 120, and a control unit 130. The information provision device 100 may include an input unit (for example, a keyboard, a mouse, or the like) that accepts various operations from an administrator of the information provision device 100, and a display unit (for example, a liquid crystal display or the like) for displaying various pieces of information. There may be a plurality of information provision devices 100, and each can be connected to be able to communicate with each other by wire or wirelessly via a predetermined communication network (a network M). The network M may be some kind of wired or wireless network, such as a local network, a wide area network, or a cloud.

### (Communication Unit 110)

The communication unit 110 is obtained by using, for example, a NIC (network interface card) or the like. The communication unit 110 is connected to the network N by wire or wirelessly, and performs transmission and reception of information with the user terminal 10, etc. via the network N. When there are a plurality of information provision devices 100, the communication unit 110 may be connected to the network M by wire or wirelessly, and may perform transmission and reception of information with an arbitrary information provision device 100 via the network M to perform processing of the information provision device 100 by distributed processing. The network N may be part of or the same as the network M.

### (Storage Unit 120)

The storage unit 120 is obtained by using, for example, a semiconductor memory element such as a RAM (random-access memory) or a flash memory, or a storage device such as a hard disk or an optical disk. As illustrated in FIG. 8, the storage unit 120 includes a model database 121 and an image data database 122.

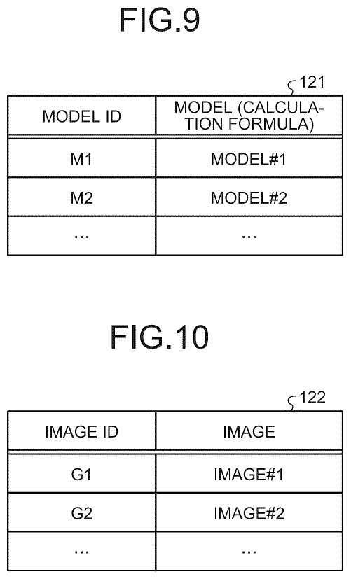

The model database 121 stores models. Here, FIG. 9 illustrates an example of the model database 121 according to the first embodiment. As illustrated in FIG. 9, the model database 121 includes items such as “model ID” and “model (calculation formula)”.

The “model ID” indicates identification information for identifying the model. The “model (calculation formula)” indicates a calculation formula of the model. Although the example illustrated in FIG. 9 illustrates an example in which conceptual information such as “model #1” and “model #2” is stored in the “model (calculation formula)”, calculation formulae or the like are stored in practice. Further, a URL where the description of a calculation formula is located, a file path name indicating a storage location, or the like may be stored.

That is, FIG. 9 illustrates an example in which the calculation formula of the model identified by the model ID “M1” is “model #1”.

The image data database 122 stores image data. Here, FIG. 10 illustrates an example of the image data database 122 according to the first embodiment. As illustrated in FIG. 10, the image data database 122 includes items such as “image ID” and “image”.

The “image ID” indicates identification information for identifying image data. The “image” indicates image data. Although the example illustrated in FIG. 10 illustrates an example in which conceptual information such as “image #1” and “image #2” is stored in the “image”, image data or the like is stored in practice. Further, for example, a URL where image data is located, a file path name indicating a storage location, or the like may be stored in the “image”.

That is, FIG. 10 illustrates an example in which the image data identified by the image ID “G1” is “image #1”.

### (Control Unit 130)

The control unit 130 is a controller, and is implemented by, for example, a process in which various programs stored in a storage device in the information provision device 100 are executed by a CPU (central processing unit), an MPU (micro processing unit), or the like using a RAM as a work area. Further, the control unit 130 is a controller, and is obtained by using, for example, an integrated circuit such as an ASIC (application-specific integrated circuit) or an FPGA (field-programmable gate array).

As illustrated in FIG. 8, the control unit 130 includes a user interface provision unit 131, an acceptance unit 132, a setting unit 133, a recognition processing execution unit 134, a post-processing execution unit 135, and a processing result provision unit 136, and achieves or executes an action of information processing described below. The internal configuration of the control unit 130 is not limited to the configuration illustrated in FIG. 8, and may be another configuration as long as it performs information processing described later.

### (User Interface Provision Unit 131)

The user interface provision unit 131 provides a user interface (see FIG. 12). Specifically, the user interface provision unit 131 transmits information for provision a user interface.

### (Acceptance Unit 132)

The acceptance unit 132 accepts various settings via the user interface provided by the user interface provision unit 131. For example, the acceptance unit 132 accepts a setting of internal control parameters (internal control variables) of processing regarding image recognition on the basis of an operation on the user interface. For example, the acceptance unit 132 accepts a setting of processing speed of recognition processing. Further, for example, the acceptance unit 132 accepts selection of, out of image data, a partial region to be subjected to recognition processing, on the basis of an operation on the user interface.

### (Setting Unit 133)

The setting unit 133 generates a model in which a setting accepted by the acceptance unit 132 is reflected. Further, the setting unit 133 generates attribute data of image data (for example, a CT image of a stomach) according to internal control parameters of a setting accepted by the acceptance unit 132, and generates close observation information (for example, a lesion such as a tumor) from the attribute data. Further, the setting unit 133 extracts, for a plurality of channels, attribute data composed of a Q value, a K value, and a V value based on a common basis function. Further, the setting unit 133 sets, as an internal control parameter, whether to extract attribute data composed of a Q value, a K value, and a V value individually calculated or to extract attribute data composed of a Q value, a K value, and a V value based on a common basis function. The setting unit 133 may generate attribute data for each of a plurality of regions obtained by dividing image data, and generate region-wise close observation information. The setting unit 133 may generate aggregation information in which features included in a plurality of adjacent regions are aggregated, generate attribute data for each aggregated region, and generate aggregated-region-wise close observation information. At this time, the setting unit 133 may set, as an internal control parameter, the number of regions for which aggregation information is to be generated. Further, the setting unit 133 may extract a region-wise feature on the basis of close observation information applied to the region, and set, as an internal control parameter, a parameter to be used when extracting a region-wise feature.

### (Recognition Processing Execution Unit 134)

The recognition processing execution unit 134 performs recognition processing by using a model generated by the setting unit 133. For example, the recognition processing execution unit 134 performs recognition processing by using a ViT.

### (Post-Processing Execution Unit 135)

The post-processing execution unit 135 executes post-processing on the basis of a processing result obtained by the recognition processing execution unit 134.

### (Processing Result Provision Unit 136)

The processing result provision unit 136 provides the user with a processing result obtained by the recognition processing execution unit 134.

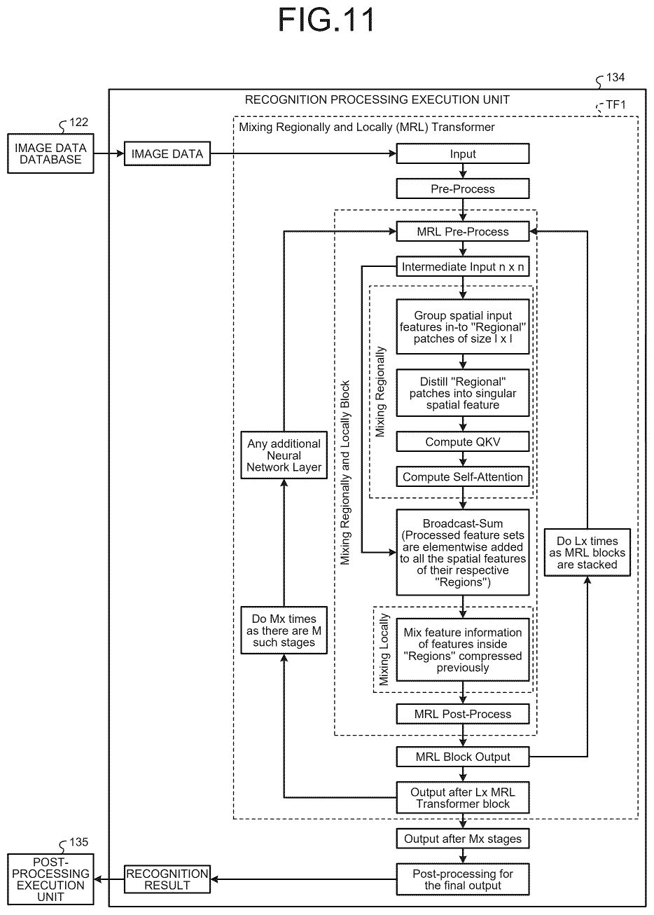

Next, processing of the recognition processing execution unit 134 is described using to FIG. 11. FIG. 11 is an explanatory diagram for describing processing of the recognition processing execution unit 134. The recognition processing execution unit 134 acquires image data from the image data database 122, and inputs the image data to a global/local mixing transformer (Mixing-Regionally-and-Locally transformer) TF1. Then, the recognition processing execution unit 134 provides, to the post-processing execution unit 135, a recognition result outputted by the transformer TF1. Various pieces of processing of the transformer TF1 will now be described.

The transformer TF1 includes a plurality of neural network layers arranged in order from a lower layer to a higher layer. The neural network system processes a neural network input to each layer, and thus generates a neural network output from the neural network input.

The transformer TF1 receives, as an object category, arbitrary digital data in the visual domain as an input, and generates a score (probability) of an arbitrary type of recognition output on the basis of the input. For example, in the case where the input is an image or features extracted from an image, the output generated for a given image by the transformer TF1 may be a score of each of object category groups, and each score may be one representing estimated likelihood in regard to whether an image of an object belonging to a category is included in the image or not. Further, for example, in the case where the input is a frame sequence of a moving image or features extracted from a moving image, the output generated for a given image by the transformer TF1 may be a predicted frame to come next, and each frame may be one representing the likelihood of an object arrangement in a given space.

The transformer TF1 includes pre-processing (a pre-process) in which neural network layers are arranged in order, and generates a neural network output. The output of the pre-processing is provided as an input to a global/local mixing block (Mixing-Regionally-and-Locally block) including neural network layers arranged in the order described below.

In the global/local mixing block, an input is transformed into a tensor represented by an intermediate output (intermediate input) n×k by MRL pre-processing (an MRL pre-process) including neural network layers. The shape of the tensor is determined by batch size for dividing the image, the number of channels, which is the number of types of features present in each region, height, width, etc. For convenience of description, the values of height and width of the tensor of the intermediate output are set to n=k; however, the embodiment is not limited thereto. For example, n and k may be different values, and the height and the width may be different values. Further, as the batch size and the number of channels, arbitrary values can be used according to the design, learning, and estimation of the neural network.

The tensor corresponding to the intermediate output n×n is provided as an input to global mixing processing (mixing regionally), which is part of the global/local mixing block. In the global mixing processing, by processing described later, extraction/exchange of feature values taking into account feature values of regions relatively distant from each other is achieved with a small number of calculation requirements.

In the global mixing processing, an n×n tensor is provided as an input to spatial input feature grouping processing (group spatial input features), and the shape input feature group, n×n, is grouped into a feature group size of 1×1 (1<n). That is, in the spatial input feature grouping processing, a feature group in adjacent regions when an image is divided into n×n regions is aggregated into a feature corresponding to one region, and thus the n×n feature group is aggregated into an 1×1 feature group. Such processing is performed for each type of feature (channel). Hereinafter, the n×n feature group may be referred to as global patches (regional patches), and the 1×1 feature group may be referred to as patches. With regard to which regions should be chosen as regions of which the feature group is to be integrated into one feature, an arbitrary aggregation method such as a shift window can be employed.

The patches generated by the spatial input feature grouping processing next serve as an input to global patch distillation processing (distil regional patches). In the global patch distillation processing, a feature vector for each of the 1×1 regions is calculated. In such global patch distillation processing, a feature vector is calculated by using a depth-wise convolutional neural network, but another neural network (for example, a predetermined weighted average layer, a maximum pooling layer, or a minimum pooling layer) may be used. The output obtained as a result of the global patch distillation processing has a tensor shape of (batch size, number of channels, m, n), where m corresponds to the number of patches each having a length of l in a feature group having a length of n.

The output from the global patch distillation processing serves as an input to QKV calculation processing (compute QKV). In the QKV calculation processing, from the output obtained as a result of the global patch distillation processing, a set of QKV values is calculated for each region of the global patches. Here, although in the first embodiment common QKV based on a common basis function is employed as a method for calculating QKV values, a conventional QKV calculation method that calculates QKV values on the basis of individual linear transformations may be employed as a method for calculating a QKV group. In the QKV calculation processing, the individual features of the input feature group are transformed by a predetermined or learned-task-specific affine transformation of the input feature group, and a Q value, a K value, and a V value are calculated. Then, in the QKV calculation processing, each of the Q value, the K value, and the V value is inputted to depth-wise convolution. In the first embodiment, a common QKV method is used to calculate a QKV group, and thereby QKV values are calculated using a common basis function instead of calculating QKV values by using individual functions; thus, the number of necessary parameters can be reduced.

The result of the QKV calculation processing serves as an input to self-attention calculation processing (compute self-attention). In the first embodiment, arbitrary various self-attention calculation methods can be used, and a detailed description is omitted. Global mixing processing is completed with such self-attention calculation processing.

Subsequently, the output of the self-attention calculation processing serves as an input to broadcast sum processing (broadcast-sum) together with the intermediate input, which served as an input to the global mixing processing. For example, in the self-attention calculation processing, a feature vector was calculated for each of the 1×1 regions generated by the spatial input feature grouping processing. In the broadcast sum processing, each of these feature vectors is applied from the respective one of the 1×1 regions to corresponding ones of n×n regions. Then, the n×n intermediate input is subjected to weighted addition with the respective feature vectors of the n×n regions, and thereby an n×n feature value group taking attention into account can be obtained. The shape of the tensor resulting from the broadcast sum processing is similar to the shape of the tensor corresponding to the spatial input feature grouping processing.

The output from the broadcast sum processing is provided as an input to local mixing processing (mixing locally) (part of the global/local mixing block). In the local mixing processing, depth-wise convolution is applied on a region basis to the region-wise feature values obtained by the self-attention calculation processing, and thereby local features are mixed. For example, in processing in local mixing, region-wise feature information mixing processing (mixing feature information inside regions) using neural network layers arranged such that feature information can be mixed in global patches is applied to the input. The method for implementing such processing is not limited to use of a specific neural network or method; a convolutional neural network, a depth-wise convolutional neural network, a group convolutional neural network, or other arbitrary convolutional neural networks may be used in view of use and implementation of an inductive bias existing in a data group in the visual domain and simplification of calculation complexity.

The output from the region-wise feature information mixing processing is provided to MRL post-processing (an MRL post-process), and an MRL block output is generated by a predetermined neural network. The information that is the MRL block output is basically a tensor that is an output from a neural network corresponding to the global/local mixing block.

Here, a number of global/local mixing blocks set by a parameter (for example, L global/local mixing blocks) are stacked, and a later-stage global/local mixing block executes similar processing to an earlier-stage global/local mixing block by using a processing result obtained by the earlier-stage global/local mixing block. Data obtained as a result of performing such Lx times of processing by global/local mixing blocks is outputted to the next-stage processing.

The data (tensor) obtained as a result of performing L times of processing by global/local mixing blocks can be further used as an input to the M-th stage global/local mixing block. The tensor thus inputted to the M-th stage serves as an input to any additional neural network system layer, and the output from the additional neural network system layer serves as an input to pre-processing to be performed again. As a result of such processing, the feature values inputted to the M-th stage can be expanded with the feature values extracted by the additional neural network system layer.

The tensor output corresponding to the output after the M stages is provided as an input to post-processing for the final output. Here, the neural network that implements the post-processing is set to be able to perform processing such that the input feature group can generate an output according to a purpose.

In the case where the transformer TF1 illustrated in FIG. 11 is used, after the neural network system operating as the transformer TF1 generates an output from learning data, a loss value is calculated on the basis of a task-specific loss function based on the output. Such a loss value is used for back propagation as part of the processing of adjusting parameter values of the neural network, and learning is executed according to the definition of back propagation of individual layers in the neural network system.

### 4. Processing According to a Second Embodiment

In the case where the transformer described above is used, there are a large number of parameters. However, it is not easy for the user to grasp what amount of processing resources (for example, processing time) will be required or what degree of accuracy will be achieved as a result of a given setting of parameters. Thus, a second embodiment provides a user interface on which the user can adjust what amount of processing resources is to be required. In the second embodiment, the values of parameters are adjusted according to a setting of processing resources accepted from the user.

For example, when the user performs an operation of reducing the amount of processing resources in order to shorten calculation time, the information provision device 100 adjusts the values of parameters such that the amount of processing resources is reduced to reduce the accuracy of image recognition. On the other hand, for example, when the user performs an operation of increasing the amount of processing resources in order to improve recognition accuracy, the information provision device 100 adjusts the values of parameters such that the accuracy of image recognition is increased.

As a result of such processing, even when there are a large number of parameters for image recognition such as when a ViT is used, the information provision device 100 can enable processing with a user-desired relationship between processing resources and recognition accuracy. As a result, by setting a relationship between processing resources and recognition accuracy, the user can easily obtain a processing result using a ViT in which parameters are automatically set.

In the MRL described above, the processing speed of the algorithm can be adjusted by controlling a plurality of hyperparameters from the outside. As well as at the time of execution of processing using MRL, for example, a procedure in which learning for a better model can be performed by adjusting hyperparameters so that the amount of processing resources is increased is possible.

FIG. 12 is an explanatory diagram for describing a user interface according to the second embodiment. The user interface according to the second embodiment provides the user with a method for controlling processing resources of an MRL algorithm. Further, the user interface provides a function of displaying processing time for an arbitrary partial image selected by the user out of an input image.

Content C10 is an example of a screen provided to the user by the information provision device 100. An image P01 is displayed in the content C10. For example, the image P1 is a CT image of a stomach. Further, a button C01 for accepting region selection from the user is placed in the content C10. When the user selects (for example, taps or clicks) the button C01, the information provision device 100 accepts region designation from the image P1. In the example illustrated in FIG. 12, the information provision device 100 accepts region designation of, out of the image P01, a region indicated by a region F01.

Further, a user control slider C02 is placed in the content C10. The information provision device 100 accepts adjustment of the processing speed (that is, processing resources) and the accuracy (the quality of image recognition) of recognition processing via an operation of the user control slider C02. For example, the user control slider C02 indicates a score value regarding processing speed, and indicates that the score value becomes higher toward the right side of the screen. The user operates such a user control slider C02 to set a score regarding processing speed.

Further, predicted processing time C03 is placed in the content C10. For example, the information provision device 100 determines a relationship between recognition accuracy and processing time according to a score designated via the user control slider C02, and determines a setting of various parameters for achieving the determined relationship. Then, when the information provision device 100 chooses the determined parameters, the information provision device 100 predicts the time it takes for image processing in the region F01, and displays the time on the screen as predicted processing time C03. When the user does not perform region selection, the information provision device 100 may display predicted processing time in the case where the entire image P01 is set as an object to be processed.

In order to display such content C10, the user interface provision unit 131 included in the information provision device 100 provides the user terminal 10 with information for displaying the screen of C10. Further, the acceptance unit 132 accepts a score as a result of an operation of the user control slider C02 by the user. In such a case, the setting unit 133 sets the values of parameters on the basis of the score accepted by the acceptance unit 132. For example, the setting unit 133 sets various parameters regarding the ViT such that, as the value of the score designated with the user control slider C02 becomes smaller, the quality of image recognition becomes higher, or the amount of processing resources becomes larger and accordingly the processing speed becomes lower; and sets various parameters regarding the ViT such that, as the value of the score designated with the user control slider C02 becomes larger, the quality of image recognition becomes lower, or the amount of processing resources becomes smaller and accordingly the processing speed becomes higher. Using parameters set in this manner, the recognition processing execution unit 134 executes image recognition processing using the ViT described above.

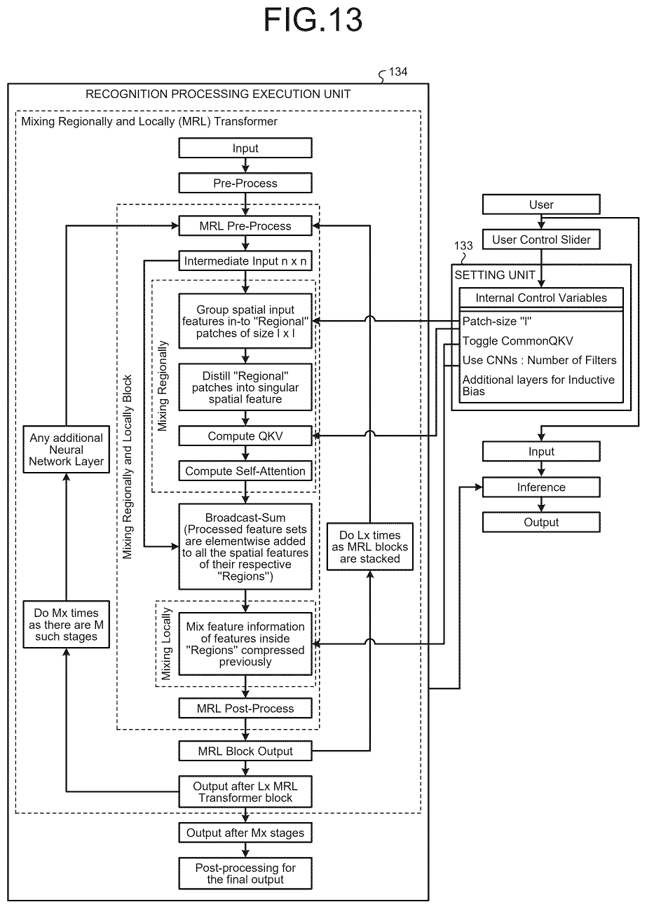

Processing of the setting unit 133 will now be described using FIG. 13. FIG. 13 is an explanatory diagram for describing processing of the setting unit 133. The processing of the recognition processing execution unit 134 on the left side of FIG. 13 is the same as that of FIG. 11, and a description is omitted as appropriate.

The user operates the user control slider C02 to control a relative desired estimated processing speed of the input. A score designated with the user control slider C02 is associated with a relative processing speed, and the setting unit 133 selects various parameters of a corresponding neural network according to the processing speed associated with the inputted score. That is, by operating the user control slider C02, the user can control parameters of a neural network, and can control the trade-off between the estimated speed of the neural network and the output accuracy of the neural network system. How the setting unit 133 selects parameters will now be described.

A patch size l (patch-size l), which is an internal control parameter, is a design hyperparameter corresponding to spatial input feature grouping processing. In the case where the value of the patch size l is small, the processing speed of the global/local mixing block is increased, but recognition accuracy as a processing result may be reduced depending on relative arrangement of global/local mixing blocks in the overall neural network architecture design. In the case where the value of the patch size l is large, the processing speed of the global/local mixing block is reduced, but recognition accuracy as a processing result may be improved depending on relative arrangement of global/local mixing blocks in the overall neural network architecture design.

A common QKV toggle (toggle common QKV), which is an internal control parameter, is a design hyperparameter corresponding to QKV calculation processing. In the case where a common QKV method is employed in the QKV calculation processing, the processing speed of the global/local mixing block is increased, but recognition accuracy as a processing result may be reduced depending on relative arrangement of global/local mixing blocks in the overall neural network architecture design. On the other hand, in the case where a common QKV method is not employed in the QKV calculation processing, the processing speed of the global/local mixing block is reduced, but recognition accuracy as a processing result may be improved depending on relative arrangement of global/local mixing blocks in the overall neural network architecture design.

The number of filters, which is an internal control parameter, is a design hyperparameter corresponding to region-wise feature information mixing processing. For example, a convolutional neural network is used to implement depth-wise convolution in the region-wise feature information mixing processing; as the number of filters per channel used here becomes larger, the processing speed of the global/local mixing block becomes higher, but recognition accuracy as a processing result may improve.

“Additional layers for inductive bias”, which is an internal control parameter, is a design hyperparameter corresponding to region-wise feature information mixing processing. In a transformer obtained by the recognition processing execution unit 134, additional layers using an inductive bias of a data set used for training can be added. For example, a group convolutional neural network layer can be added to the transformer in order to use an inductive bias related to rotational symmetry. In the case where such an additional layer is added, the processing speed of the global/local mixing block is reduced, but recognition accuracy as a processing result may be improved.

The setting unit 133 automatically sets the above-described various design hyperparameters on the basis of the score set by the user using the user control slider C02. That is, the setting unit 133 sets design hyperparameters such as the patch size l, the common QKV toggle, the number of filters, and additional layers for inductive bias according to the value of the user control slider. The recognition processing execution unit 134 executes recognition processing by using a transformer in which the setting by the setting unit 133 is used.

For example, in the case where the user performs an operation of increasing processing speed by increasing the value of the score indicated by the user control slider C02, the setting unit 133 performs parameter setting such as reducing the value of the patch size l, turning on the common QKV toggle, reducing the number of filters, or reducing the number of additional layers for inductive bias. Further, for example, in the case where the user performs an operation of increasing accuracy by reducing the value of the score indicated by the user control slider C02, the setting unit 133 performs parameter setting such as increasing the value of the patch size l, turning off the common QKV toggle, increasing the number of filters, or increasing the number of additional layers for inductive bias.

The setting unit 133 adjusts processing speed by performing parameter setting such as changing the setting of at least one or more parameters among parameters such as the value of the patch size l, the on/off of the common QKV toggle, the number of filters, and the number of additional layers for inductive bias, and achieves a user-desired processing speed. In the case where the setting of these parameters is predetermined in association with the value of the user control slider on a rule basis, the setting unit 133 may set one or a plurality of these parameters on the basis of the association in which such a rule is determined. For example, when the user changes the value of the user control slider, the setting unit 133 may, on the basis of the association, extract a setting of parameters predetermined in association with the changed value after change by the user, and determine the extracted setting of parameters as a new setting of parameters.

### 5. Hardware Configuration Example

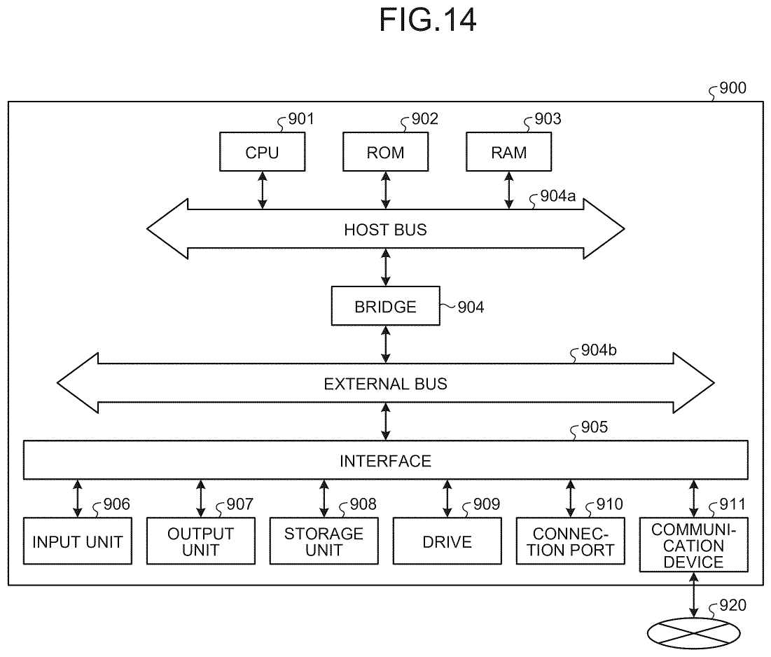

Finally, a hardware configuration example of the information provision device according to the embodiment is described with reference to FIG. 14. FIG. 14 is a block diagram illustrating a hardware configuration example of the information provision device according to the embodiment. An information provision device 900 illustrated in FIG. 14 can provide, for example, the user terminal 10 and the information provision device 100 illustrated in FIG. 8. Information processing by the user terminal 10 and the information provision device 100 according to the embodiment is implemented by cooperation of software and hardware described below.

As illustrated in FIG. 14, the information provision device 900 includes a CPU (central processing unit) 901, a ROM (read-only memory) 902, and a RAM (random-access memory) 903. Further, the information provision device 900 includes a host bus 904a, a bridge 904, an external bus 904b, an interface 905, an input device 906, an output device 907, a storage device 908, a drive 909, a connection port 910, and a communication device 911. The hardware configuration illustrated here is an example, and some of the components may be omitted. Further, the hardware configuration may further include components other than the components illustrated here.

The CPU 901 functions as, for example, an arithmetic processing device or a control device, and controls all or some of the operations of the components on the basis of various programs recorded on the ROM 902, the RAM 903, or the storage device 908. The ROM 902 is a means for storing a program to be read by the CPU 901, data used for calculation, etc. The RAM 903 temporarily or permanently stores, for example, a program to be read by the CPU 901, various parameters that change as appropriate when the program is executed, etc. These are connected to each other by a host bus 904a formed of a CPU bus or the like.

The CPU 901, the ROM 902, and the RAM 903 are connected to each other via, for example, a host bus 904a capable of high-speed data transmission. On the other hand, the host bus 904a is connected to an external bus 904b having a relatively low data transmission speed via the bridge 904, for example. The external bus 904b is connected to various components via the interface 905.

The input device 906 is obtained by using, for example, a device through which information is inputted by a listener, such as a mouse, a keyboard, a touch panel, a button, a microphone, a switch, or a lever. The input device 906 may be a remote control device using infrared rays or other radio waves, or may be an externally connected device such as a mobile phone or a PDA adapted to the operation of the information provision device 900, for example. The input device 906 may include, for example, an input control circuit or the like that generates an input signal on the basis of information inputted using the above input means and outputs the input signal to the CPU 901. By operating the input device 906, the administrator of the information provision device 900 can input various pieces of data to the information provision device 900, and instruct the information provision device 900 to perform a processing operation.

In addition, the input device 906 can be formed by a device that detects the position of the user. For example, the input device 906 may include various sensors such as an image sensor (for example, a camera), a depth sensor (for example, a stereo camera), an acceleration sensor, a gyro sensor, a geomagnetic sensor, an optical sensor, a sound sensor, a distance measurement sensor (for example, a ToF (time-of-flight) sensor), and a force sensor. The input device 906 may acquire information regarding the state of the information provision device 900 itself, such as the attitude and moving speed of the information provision device 900, and information regarding the surrounding space of the information provision device 900, such as brightness and noise around the information provision device 900. The input device 906 may include a GNSS module that receives a GNSS signal from a GNSS (global navigation satellite system) satellite (for example, a GPS signal from a GPS (global positioning system) satellite) and measures position information including the latitude, longitude, and altitude of the device. For the position information, the input device 906 may detect the position by Wi-Fi (registered trademark), transmission and reception or near-field communication with a mobile phone, a PHS, a smartphone, or the like, etc.

The output device 907 is formed of a device capable of visually or aurally notifying the user of the acquired information. Examples of such a device include display devices such as a CRT display device, a liquid crystal display device, a plasma display device, an EL display device, a laser projector, an LED projector, and a lamp, sound output devices such as a speaker and a headphone, a printer device, etc. The output device 907 outputs, for example, results obtained by various pieces of processing performed by the information provision device 900. Specifically, the display device visually displays results obtained by various pieces of processing performed by the information provision device 900 in various formats such as text, images, tables, and graphs. On the other hand, the sound output device converts an audio signal composed of reproduced sound data, acoustic data, or the like into an analog signal, and aurally outputs the analog signal.

The storage device 908 is a device for data storage formed as an example of a storage unit of the information provision device 900. The storage device 908 is obtained by using, for example, a magnetic storage unit device such as an HDD, a semiconductor storage device, an optical storage device, a magneto-optical storage device, or the like. The storage device 908 may include a storage medium, a recording device that records data on a storage medium, a reading device that reads data from a storage medium, a deletion device that deletes data recorded on a storage medium, etc. The storage device 908 stores a program and various pieces of data to be executed by the CPU 901, various pieces of data acquired from the outside, etc.

The drive 909 is a reader/writer for a storage medium, and is built in or externally attached to the information provision device 900. The drive 909 reads information recorded on a removable storage medium such as a mounted magnetic disk, optical disk, magneto-optical disk, or semiconductor memory, and outputs the information to the RAM 903. The drive 909 can also write information on a removable storage medium.

The connection port 910 is, for example, a USB (universal serial bus) port, an IEEE 1394 port, an SCSI (small computer system interface), an RS-232C port, or a port for connecting an externally connected device such as an optical audio terminal.

The communication device 911 is, for example, a communication interface formed of a communication device or the like for connection to a network 920. The communication device 911 is, for example, a communication card or the like for a wired or wireless LAN (local area network), LTE (long term evolution), Bluetooth (registered trademark), or WUSB (wireless USB). The communication device 911 may be a router for optical communication, a router for ADSL (asymmetric digital subscriber line), a modem for various communications, or the like. The communication device 911 can, for example, perform transmission and reception of signals, etc. with the Internet or other communication devices according to, for example, a predetermined protocol such as TCP/IP.

The network 920 is a wired or wireless transmission path of information transmitted from a device connected to the network 920. For example, the network 920 may include a public network such as the Internet, a telephone network, or a satellite communication network, various LANs (local area networks) including Ethernet (registered trademark), a WAN (wide area network), or the like. Further, the network 920 may include a dedicated network such as IP-VPN (internet protocol-virtual private network).

Hereinabove, an example of the hardware configuration capable of implementing the functions of the information provision device 900 according to the embodiment is described. Each of the above components may be obtained by using general-purpose members, or may be obtained by hardware specialized for the function of the component. Therefore, the hardware configuration to be used can be changed according to the technical level on each occasion of implementing the embodiment, as appropriate.

### 6. Conclusions

As described hereinabove, an image processing method according to an embodiment executes processing of: accepting, from a user, an input regarding execution of image processing using a learning model; setting, according to the accepted input, a control parameter of processing regarding image recognition; generating, according to the control parameter, attribute data of image data to be processed; generating, according to the control parameter, close observation information from the attribute data; and performing image recognition on the basis of the close observation information. Thereby, the image processing method according to the embodiment can enable the user to easily recognize how the accuracy of the ViT and the amount of resources required for processing change when a setting of various hyperparameters is changed.

Therefore, an image processing method, an information provision device, and an information provision program capable of enabling the user to easily recognize how the accuracy of the ViT and the amount of resources required for processing change when a setting of various hyperparameters is changed can be provided.

Hereinabove, preferred embodiments of the present disclosure are described in detail with reference to the appended drawings; however, the technical scope of the present disclosure is not limited to such examples. It is clear that a person having ordinary knowledge in the technical field of the present disclosure can conceive various changes or modifications within the scope of the technical idea described in the claims, and it is naturally understood that also these fall within the technical scope of the present disclosure.

The series of processing by each device described in the present specification may be implemented using any of software, hardware, and a combination of software and hardware. The program constituting the software is stored in advance in, for example, a recording medium (non-transitory medium) provided inside or outside each device. Then, each program is, for example, read into a RAM at the time of execution by a computer, and executed by a processor such as a CPU.

The processing described using a flowchart in the present specification may not necessarily be executed in the illustrated order. Some processing steps may be performed in parallel. The processing may also be executed by distributed processing using a plurality of devices connected via a network. Further, additional processing steps may be used, and some processing steps may be omitted.

The effects described in the present specification are merely exemplary or illustrative, and are not limitative. That is, the technology according to the present disclosure can exhibit other effects that are clear to those skilled in the art from the description of the present specification, together with or instead of the above effects.

Also the following configurations fall within the technical scope of the present disclosure.

(1)

An image processing method including execution of processing of:
accepting, from a user, an input regarding execution of image processing using a learning model;
setting, according to the accepted input, a control parameter of processing regarding image recognition;
generating, according to the control parameter, attribute data of image data to be processed;
generating, according to the control parameter, close observation information from the attribute data; and
performing image recognition on the basis of the close observation information.
   (2)

The image processing method according to (1), wherein
information indicating a relationship between quality of image recognition and processing speed is accepted as the input.
   (3)

The image processing method according to (2), wherein
the input is accepted via content in which a value is changeable in a predetermined range,
the control parameter is set such that, as an inputted value becomes smaller, quality of the image recognition becomes higher, and
the control parameter is set such that, as an inputted value becomes larger, processing speed required for the image recognition becomes higher.
   (4)

The image processing method according to any one of (1) to (3), wherein
attribute data composed of a query value, a key value, and a value value based on a common basis function is extracted as the attribute data.
   (5)

The image processing method according to (4), wherein
whether to extract attribute data composed of a query value, a key value, and a value value individually calculated or to extract attribute data composed of a query value, a key value, and a value value based on a common basis function is set as the control parameter.
   (6)

The image processing method according to any one of (1) to (5), wherein
the image data is divided into a plurality of regions,
the attribute data is generated for each of the regions,
close observation information for each of the regions is generated on the basis of the attribute data, and
image recognition of entirety of the image data is performed on the basis of the close observation information.
   (7)

The image processing method according to (6), wherein
aggregation information in which features included in a plurality of adjacent regions are aggregated is generated,
the attribute data is generated for each of aggregated regions on the basis of the aggregation information,
close observation information for each of the aggregated regions is generated on the basis of the attribute data,
common close observation information generated is applied to a plurality of aggregated regions, and
image recognition of the entirety of the image data is performed on the basis of close observation information applied to each region.
   (8)

The image processing method according to (7), wherein
a number of regions for which the aggregation information is to be generated is set as the control parameter.
   (9)

The image processing method according to (7) or (8), wherein
a region-wise feature is extracted on the basis of the close observation information applied to each region,
image recognition of the entirety of the image data is performed on the basis of region-wise features, and
a parameter to be used when extracting the region-wise feature is set as the control parameter.
   (10)

The image processing method according to any one of (1) to (9), wherein
designation of a partial region of the image data is further accepted,
processing time it takes when image recognition of the designated partial region is performed is estimated according to the control parameter, and
the estimated time is displayed.
   (11)

An information provision device including a control unit that executes processing of:
accepting, from a user, an input regarding execution of image processing using a learning model;
setting, according to the accepted input, a control parameter of processing regarding image recognition;
generating, according to the control parameter, attribute data of image data to be processed;
generating, according to the control parameter, close observation information from the attribute data; and
performing image recognition on the basis of the close observation information.
   (12)

An information provision program causing a computer to execute processing of:
accepting, from a user, an input regarding execution of image processing using a learning model;
setting, according to the accepted input, a control parameter of processing regarding image recognition;
generating, according to the control parameter, attribute data of image data to be processed;
generating, according to the control parameter, close observation information from the attribute data; and
performing image recognition on the basis of the close observation information.

### REFERENCE SIGNS LIST

1 INFORMATION PROVISION SYSTEM
10 USER TERMINAL
100 INFORMATION PROVISION DEVICE
110 COMMUNICATION UNIT
120 STORAGE UNIT
121 MODEL DATABASE
122 IMAGE DATA DATABASE
130 CONTROL UNIT
131 USER INTERFACE PROVISION UNIT
132 ACCEPTANCE UNIT
133 SETTING UNIT
134 RECOGNITION PROCESSING EXECUTION UNIT
135 POST-PROCESSING EXECUTION UNIT
136 PROCESSING RESULT PROVISION UNIT

1. An image processing method including execution of processing of:
accepting, from a user, an input regarding execution of image processing using a learning model;
setting, according to the accepted input, a control parameter of processing regarding image recognition;
generating, according to the control parameter, attribute data of image data to be processed;
generating, according to the control parameter, close observation information from the attribute data; and
performing image recognition on the basis of the close observation information.

2. The image processing method according to claim 1, wherein
information indicating a relationship between quality of image recognition and processing speed is accepted as the input.

3. The image processing method according to claim 2, wherein
the input is accepted via content in which a value is changeable in a predetermined range,
the control parameter is set such that, as an inputted value becomes smaller, quality of the image recognition becomes higher, and
the control parameter is set such that, as an inputted value becomes larger, processing speed required for the image recognition becomes higher.

4. The image processing method according to claim 1, wherein
attribute data composed of a query value, a key value, and a value value based on a common basis function is extracted as the attribute data.

5. The image processing method according to claim 4, wherein
whether to extract attribute data composed of a query value, a key value, and a value value individually calculated or to extract attribute data composed of a query value, a key value, and a value value based on a common basis function is set as the control parameter.

6. The image processing method according to claim 1, wherein
the image data is divided into a plurality of regions,
the attribute data is generated for each of the regions,
close observation information for each of the regions is generated on the basis of the attribute data, and
image recognition of entirety of the image data is performed on the basis of the close observation information.

7. The image processing method according to claim 6, wherein
aggregation information in which features included in a plurality of adjacent regions are aggregated is generated,
the attribute data is generated for each of aggregated regions on the basis of the aggregation information,
close observation information for each of the aggregated regions is generated on the basis of the attribute data,
common close observation information generated is applied to a plurality of aggregated regions, and
image recognition of the entirety of the image data is performed on the basis of close observation information applied to each region.

8. The image processing method according to claim 7, wherein
a number of regions for which the aggregation information is to be generated is set as the control parameter.

9. The image processing method according to claim 7, wherein
a region-wise feature is extracted on the basis of the close observation information applied to each region,
image recognition of the entirety of the image data is performed on the basis of region-wise features, and
a parameter to be used when extracting the region-wise feature is set as the control parameter.

10. The image processing method according to claim 1, wherein
designation of a partial region of the image data is further accepted,
processing time it takes when image recognition of the designated partial region is performed is estimated according to the control parameter, and
the estimated time is displayed.

11. An information provision device including a control unit that executes processing of:
accepting, from a user, an input regarding execution of image processing using a learning model;
setting, according to the accepted input, a control parameter of processing regarding image recognition;
generating, according to the control parameter, attribute data of image data to be processed;
generating, according to the control parameter, close observation information from the attribute data; and
performing image recognition on the basis of the close observation information.

12. An information provision program causing a computer to execute processing of:
accepting, from a user, an input regarding execution of image processing using a learning model;
setting, according to the accepted input, a control parameter of processing regarding image recognition;
generating, according to the control parameter, attribute data of image data to be processed;
generating, according to the control parameter, close observation information from the attribute data; and
performing image recognition on the basis of the close observation information.
